(19) United States
(12) Patent Application Publication
(10) Pub. No.: US 2025/0018648 A1
(43) Pub. Date: Jan. 16, 2025

(54) Stereolithography System with Parallel Processing Between Layer Formation and Selective Curing

(71) Applicant: 3D Systems, Inc., Rock Hill, SC (US)

(72) Inventors: Patrick Dunne, Lafayette, CA (US); Eric M. Innes, San Diego, CA (US)

(21) Appl. No.: 18/768,361

(22) Filed: Jul. 10, 2024

Related U.S. Application Data
(60) Provisional application No. 63/513,035, filed on Jul. 11, 2023.

(51) Int. Cl. B29C 64/273; B29C 64/135; B29C 64/255; B29C 64/393; B29K 105/00; B29K 105/16; B33Y 10/00; B33Y 30/00; B33Y 50/02

(52) U.S. Cl. CPC B29C 64/273; B29C 64/135; B29C 64/255; B29C 64/393; B33Y 10/00; B33Y 30/00; B33Y 50/02; B29K 2105/0002; B29K 2105/0014; B29K 2105/16

(57) ABSTRACT

A three-dimensional (3D) printing system includes a vessel configured to contain a photocurable resin, a coating subsystem including a coater blade, a build plate coupled to a vertical movement mechanism, an imaging system configured to selectively image the photocurable resin at a build plane, and a controller. The controller is configured to operate the vertical movement mechanism to position an upper surface of the build plate at the build plane, translate a lower edge of the coater blade over the build plane along a scan direction, and concurrent with translating the lower edge of the coater blade, operate the imaging system to selectively image the build plane while maintaining an exclusion zone that includes a digital shadow that translates with the coater blade, the digital shadow includes an area of the coater blade and a fluidic wake area that follows the coater blade.

### CROSS-REFERENCE TO RELATED APPLICATIONS

This non-provisional patent application claims priority to U.S. Provisional Application Ser. No. 63/513,035, Entitled “Stereolithography System with Parallel Processing Between Layer Formation and Selective Curing” by Patrick Dunn et al., filed on Jul. 11, 2023, incorporated herein by reference under the benefit of U.S.C. 119(e).

### FIELD OF THE INVENTION

The present disclosure concerns an apparatus and method for the digital fabrication of three-dimensional (3D) articles by a layer-by-layer selective radiative curing of a photocurable build material. More particularly, the present disclosure concerns a way of reducing a total fabrication time by concurrently dispensing and radiatively curing a build material layer.

### BACKGROUND

3D printing systems are in wide use for prototyping and manufacturing articles. One type of 3D printing system utilizes a process called stereolithography. A typical stereolithography system utilizes a resin vessel, an imaging system, and a build plate within liquid photocurable resin held by the resin vessel. An article is manufactured in a layer-by-layer manner by selectively imaging and radiatively curing layers of the photocurable resin over the build plate. There is an ongoing desire to improve productivity of 3D printing systems.

### SUMMARY

In an aspect of the disclosure, a three-dimensional (3D) printing system includes a vessel configured to contain a photocurable resin, a coating subsystem including a coater blade, a build plate coupled to a vertical movement mechanism, an imaging system configured to selectively image the photocurable resin at a build plane, and a controller. The controller is configured to operate the vertical movement mechanism to position an upper surface of the build plate at the build plane, translate a lower edge of the coater blade over the build plane along a scan direction, and concurrent with translating the lower edge of the coater blade, operate the imaging system to selectively image the build plane while maintaining an exclusion zone that includes a digital shadow that translates with the coater blade, the digital shadow includes an area of the coater blade and a fluidic wake area that follows the coater blade.

Concurrently operating translating the coater blade and operating the imaging system increases productivity of the system. Additionally, use of the digital shadow assures that a fluidic wake from the blade will not adversely affect quality of a manufactured layer.

In one implementation, the controller is configured to compute a width W of a fluidic wake based upon one or more parameters. The one or more parameters can include one or more of a layer thickness of a new layer of resin, a photocurable resin viscosity, and a geometry of the lower edge of the blade. The computed value of W can be empirically determined for these parameters and stored as a lookup table. Empirical determination can include scanning the wake with a non-contact profilometer while the coating process takes place.

In another implementation, the imaging system includes a laser and a scanner. The laser is configured to output an energy beam. The scanner is configured to scan the energy beam over the build plane. The scanner can include a galvanometer mirror. The galvanometer mirror can be a single galvanometer mirror configured to rotate along two axes. Alternatively, the galvanometer mirror can include a series of two galvanometer mirrors including a first galvanometer mirror (X-mirror) configured to scan the energy beam along a first lateral X-axis and a second galvanometer mirror (Y-mirror) configured to scan the energy beam along a second lateral Y-axis. The imaging system can also include focusing optics for focusing the energy beam upon the build plane. The imaging system can also include flat field or f-theta optics for assuring that the energy beam presents a consistent cross sectional area across the build plane.

In yet another implementation, the imaging system includes a light source, a spatial light modulator, and projection optics. The light source is configured to emit radiation having a wavelength in the blue to ultraviolet range or from about 100 to 500 nanometers. The radiation emitted by the light source is received by the spatial light modulator. The spatial light modulator can include a micromirror array which includes an array of reflective mirrors. The spatial light modulator selectively passes modulated radiation to the projection optics. The projection optics focuses the modulated radiation upon the build plane.

### BRIEF DESCRIPTION OF THE FIGURES

FIG. 1 is a schematic illustration of an embodiment of a three-dimensional (3D) printing system for manufacturing or fabricating a 3D article.

FIG. 2 is an isometric drawing that illustrates certain components of an embodiment of a three-dimensional (3D) printing system for manufacturing or fabricating a 3D article.

FIG. 3 is an isometric drawing of an embodiment of a coating subsystem in isolation.

FIG. 4 is an isometric cutaway view of an embodiment of a coater blade in isolation.

FIG. 5 is a flowchart depicting a method of manufacturing a 3D article.

FIG. 6A is a diagram depicting a build plane at the beginning of a wiper blade scan.

FIG. 6B is a diagram depicting a build plane as a wiper is passing over an upper surface of a 3D article being formed.

FIG. 6C is a diagram depicting a build plane as a wiper has passed an upper surface of a 3D article being formed.

### DETAILED DESCRIPTION OF THE PREFERRED EMBODIMENTS

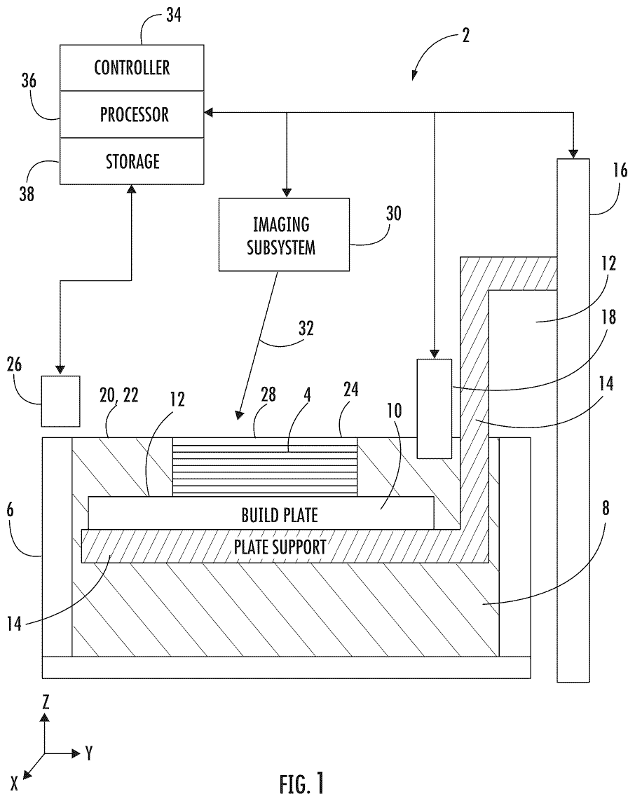

FIG. 1 is a schematic illustration of an embodiment of a three-dimensional (3D) printing system 2 for manufacturing or fabricating a 3D article 4. In describing system 2, mutually orthogonal axes X, Y, and Z will be utilized and otherwise referred to as an X-axis, a Y-axis, and a Z-axis. Axes X and Y are lateral axes that are generally horizontal. The Z-axis is a vertical axis that is generally aligned with a gravitational reference. The term “generally” implies that a direction or magnitude is not necessarily exact but is by design. Thus the term “generally horizontal” means horizontal (perpendicular to a gravitational vector) to within design and manufacturing tolerances. The term “generally aligned” means aligned to within design and manufacturing tolerances.

3D printing system 2 includes a resin vessel 6 for containing a photocurable resin 8. In the illustrated embodiment, photocurable resin 8 includes, inter alia, a monomer, a catalyst, and a filler. The catalyst allows the resin 8 to be hardened and cured with an application of radiation such as blue radiation, violet radiation, or ultraviolet radiation that would typically have a wavelength in a range of 100 to 500 nm (nanometers). Photocurable resins for stereolithography systems are known in the art.

System 2 includes a build plate 10 with an upper surface 12 upon which the 3D article 4 is formed. A build plate support structure 14 supports build plate 10. A vertical movement mechanism 16 is operable to vertically position the build plate support structure 14 and in doing so vertically position the build plate 10. In one embodiment, the vertical movement mechanism 16 includes a fixed motor coupled to a lead screw. The build plate support structure 14 includes a threaded bearing that receives the lead screw. As the motor turns the lead screw, the effect is to controllably translate the build plate support structure 14 up or down. In addition, the vertical movement mechanism 16 and the build plate support structure 14 include mutually engaging linear bearings that assure linear motion of the build plate support structure along the vertical axis Z. Various vertical and lateral movement mechanisms are known in the field of stereolithography. All typically include linear bearings for guiding motion but the movement can be based upon a lead screw, a rack and pinion system, a belt and pulley system, or well-known means of imparting motion.

System 2 includes a resin level subsystem 18 configured to maintain a resin upper surface 20 at a predetermined vertical position. In the illustrated embodiment, the resin upper surface 20 is generally coincident with a build plane 22. The resin level subsystem 18 can include a resin level sensor and a weight coupled to a pulley system. The weight is partially immersed in the resin 8 such that raising and lowering the weight alters a vertical position of the resin upper surface 20 via volumetric displacement. The resin level sensor outputs a signal indicative of a vertical position of the resin upper surface 20. The signal is analyzed and the pulley system is operated to raise and lower the weight to maintain the resin upper surface 20 to be generally coincident with the build plane 22. Resin level subsystems 18 are known in the art for stereolithography systems 2.

An “upper surface” 24 can be defined which is either the upper surface 12 or an upper surface 24 of the 3D article 4 when it is partially formed. Before forming an additional material layer onto the 3D article 4, the upper surface 24 is positioned at a vertical position that is generally one material layer thickness below the build plane 22.

System 2 includes a coating subsystem 26. After upper surface 24 is positioned one layer thickness below build plane 22, the coating subsystem 26 is configured to pass over the upper surface and to define a new layer 28 of the resin 8 over the upper surface 24. Details of the coating subsystem 26 will be discussed infra. The new layer 28 of resin 8 has the resin upper surface 20 that is generally coincident with build plane 22.

System 2 includes an imaging subsystem 30. Imaging subsystem 30 is configured to scan an energy beam 32 over the build plane 22 to selectively cure and harden the new layer 28 of resin 8 and to form a new material layer of the 3D article 4. In an illustrative embodiment, imaging subsystem 30 includes a laser that generates a radiation beam 32 that is reflected by a scanner. The scanner scans the radiation beam 32 over the build plane 22. In an illustrative embodiment, the scanner includes two galvanometer mirrors including an X-mirror and a Y-mirror configured to scan the radiation beam along the X-axis and the Y-axis respectively over the build plane 22. Imaging subsystems are known in the field of stereolithography.

In another embodiment, imaging subsystem 30 includes a light source, a reflective micromirror array, and projection optics. The light source illuminates the micromirror array. Individual mirrors in the micromirror array have two states including an ON state and an OFF state. In the ON state, a mirror reflects a pixel of light through the projection optics and to the build plane 22. In the OFF state, the mirror reflects a pixel of light to a light trap that absorbs the light. In this way, the imaging subsystem 30 selectively illuminates an array of pixels over the build plane 22. Such imaging subsystems are known as “DLP systems” or digital light processing subsystems and are known in the art of stereolithography.

Whether the imaging system 30 uses a scanning laser or pixel array, the light for selective curing is selected from a wavelength that is in the blue to ultraviolet range or from about 100 to 500 nanometers. The photocurable resin 8 catalyst is sensitive to the selected wavelength.

A controller 34 is coupled to the vertical movement mechanism 16, the resin level subsystem 18, the coating subsystem 26, the imaging subsystem 30, and other portions of system 2. The controller 34 includes a processor 36 (such as a CPU or central processing unit) coupled to a non-transient information storage device 38 (such as flash memory). Storage device 38 stores software instructions. Controller 34 is configured to operate the portions of system 2 as the processor 36 executes the software instructions stored on the non-transient information storage device 38. Controller 34 can include a single unit that is associated with system 2 or it can include a plurality of control units that can be co-located with and or remotely located relative to the illustrated system 2.

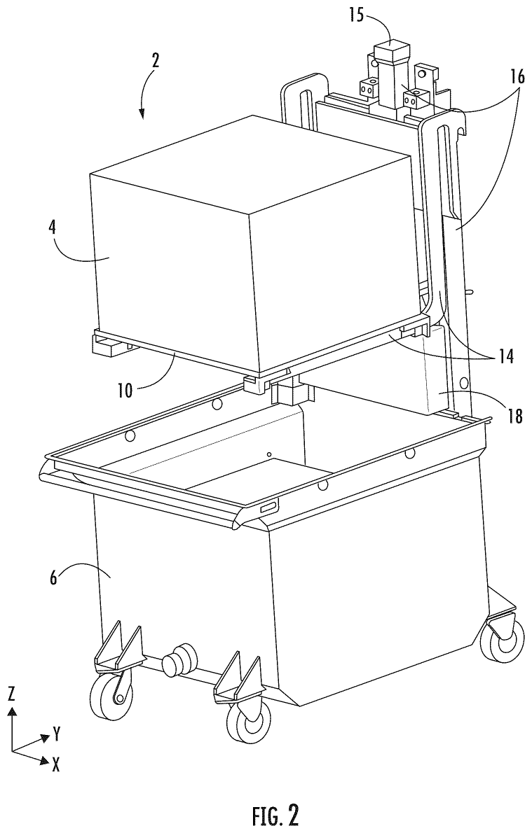

FIG. 2 is an isometric drawing that illustrates certain components of an embodiment of system 2. In the illustrated embodiment from a user point of view the axes X, Y, and Z can be described. The lateral X-axis extends from left to right. The lateral Y-axis extends from front to back or from front to rear. The vertical Z-axis extends upward. The illustrated components include the resin vessel 6, build plate 10, build plate support structure 14, vertical movement mechanism 16, and resin level subsystem 18 (the weight that is raised and lowered is shown in FIG. 2). The vertical movement mechanism 16 includes a motor 15 coupled to a vertical lead screw for providing vertical positioning of the build plate support structure 14 and the build plate 10. Between the build plate support structure 14 and the vertical movement mechanism 16 are a pair of linear bearings (hidden in this figure) to control linearity of motion along the Z-axis. Not illustrated is the coating subsystem 26 and imaging subsystem 30.

FIG. 3 is an isometric drawing of an embodiment of a coating subsystem 26 in isolation. Coating subsystem 26 includes a wiper module 40 or coater module 40 which includes a coater blade 42 that is supported between two end portions 44 which are at opposed ends of the coater blade 42 with respect to the lateral X-axis.

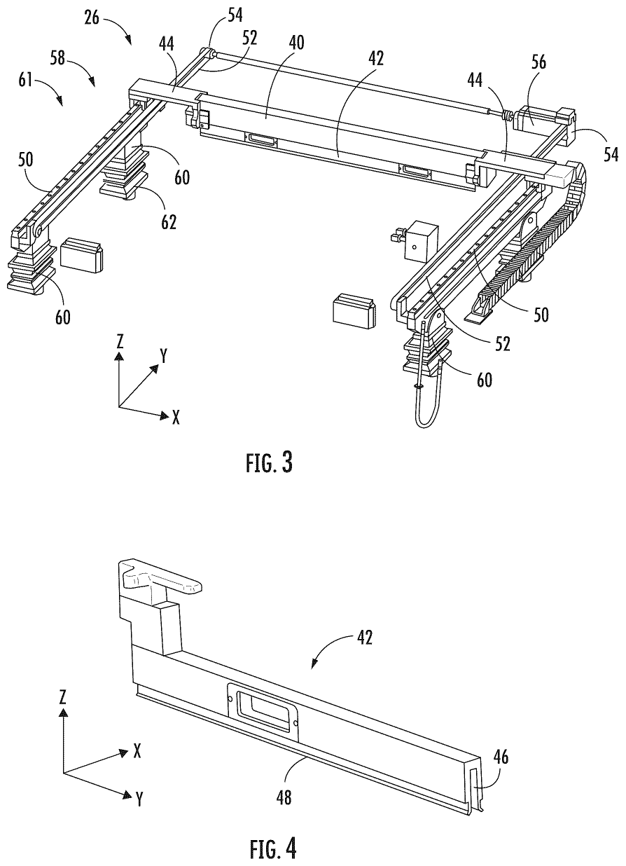

FIG. 4 is an isometric cutaway view of the coater blade 42 in isolation. One end of the cutaway view illustrates an internal recess 46 that is at least partially filled with resin 8 to facilitate coating irregular upper surfaces 24 of 3D articles 4. Coater blade 42 also has a lower edge 48.

Referring back to FIG. 3, coating subsystem 26 includes a pair of linear bearings 50 at opposed ends of the coater module 40 with respect to the X-axis. The end portions 44 are in sliding engagement with and supported by the linear bearings 50. The end portions 44 slide upon the linear bearings 50 along the Y-axis.

Two belts 52 are individually supported by pulleys 54 at opposed ends of the coater module 40. The belts 52 are attached to the end portions 44 at the opposed ends of the coater module 40. A motor 56 is coupled to two of the pulleys 54. Rotation of the pulleys 54 by motor 56 causes movement of the belt and translation of the coater module 40 along the Y-axis in sliding engagement and support by the linear bearings 50. The combination of the motor 56, pulleys 54, belts 52, and other possible components can be referred to as a “lateral movement mechanism” 58 for transporting coater module 40 along the Y-axis.

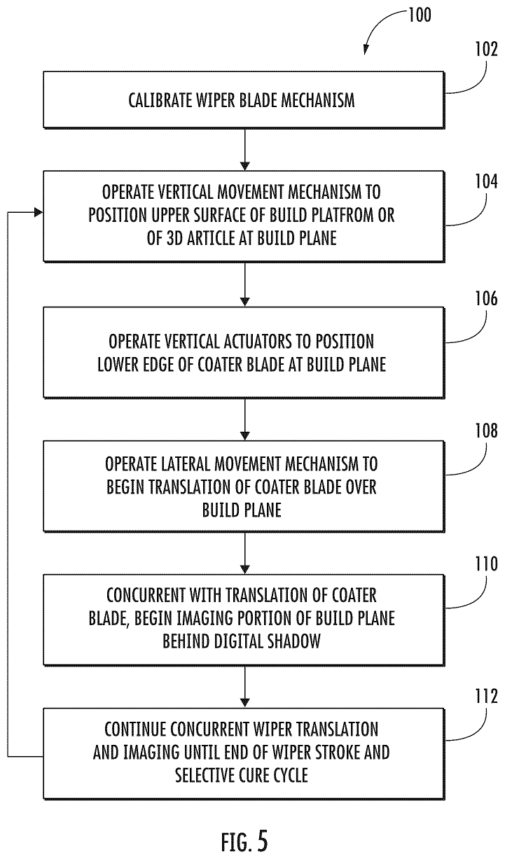

A set of four vertical actuators 60 support and vertically position the linear bearings 50. The vertical actuators 60 are individually coupled between a vertical support 62 (FIG. 5) and one of the linear bearings 50. The linear bearings 50 individually are supported by a front vertical actuator 60 and a rear vertical actuator 60 which enables a height and angular tilt of each linear bearing 50 to be adjusted. In one embodiment, the vertical actuators 60 individually include a motorized lead screw that turns and thereby raises or lowers a nut that is attached to one end portion of one of the linear bearings 50. The set of four vertical actuators 60 and other associated components can be referred to as a “vertical actuator system” 61.

FIG. 5 is a flowchart depicting a method 100 for manufacturing the 3D article 4 using the 3D printing system 2. Method 100 is performed by controller 34, as processor 36 execute software instructions stored within information storage device(s) 38. In this way, controller 34 is configured to operate components of 3D printing system 2 to execute the steps of method 100.

According to 102, the coating subsystem 26 is calibrated. This assures that the lower edge 48 of coater 42 can be positioned vertically to coincide with the build plane 22.

According to 104, the vertical movement mechanism 16 is operated to position the upper surface 12 of the build plate 10 (or later the upper surface 24 of 3D article 4) at the build plane 22. According to 106, the vertical actuator system 61 is operated to properly level and vertically position the lower edge 48 of coater 42 at the build plane 22.

According to 108, the lateral movement mechanism 58 is operated to translate the coater 42 over the build plane 22. According to 110, concurrent with step 108, the imaging subsystem 30 is operated to selectively cure a new layer 28 of the photocurable resin 8 over the upper surface 12 or 24. The selective curing of step 110 begins while the coater 42 is still translating over the build plane 22. According to 112, the concurrent action of steps 108 and 110 are continued until the new layer 28 is selectively cured. The method 100 then loops from 112 back to step 104 for formation and selective curing of another new layer 28.

As part of method 100, the width W of the fluidic wake can be determined based upon a lookup table that is stored in controller 34. The lookup table can relate W to various parameters including photocurable resin 8 viscosity, layer thickness, coater blade 42 translation velocity, and a geometry of the lower edge 48 of the coater blade 42. The determination of W can be performed empirically for various input parameters by scanning the resin 8 surface with a non-contact optical profilometer while performing the coating operation. Three-dimensional (3D) profilometers are known in the art for fields such as metrology. These profilometers and almost instantly scan and determine a surface geometry.

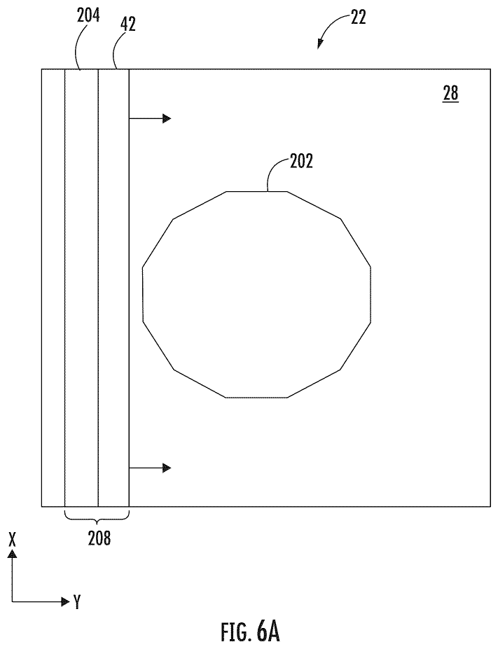

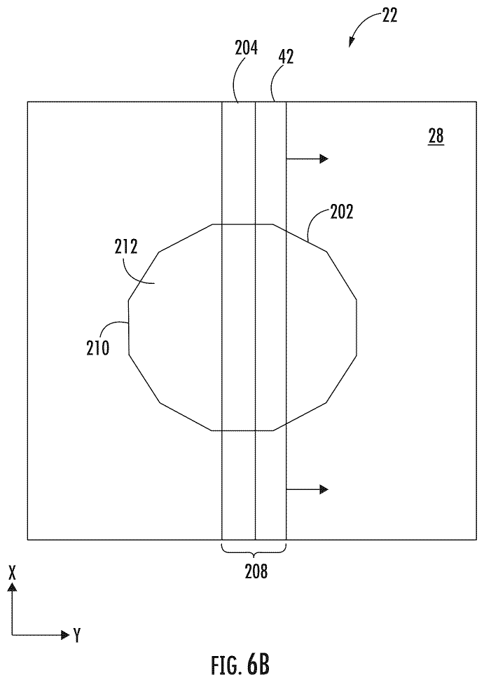

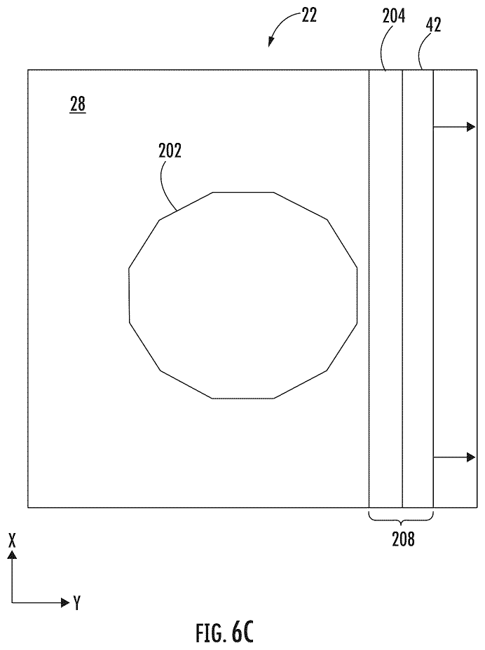

FIGS. 6A-C are schematic top view illustrations of the build plane 22 at different points in time during steps 108-112 of method 100. Referring to FIG. 6A, the polygonal shaped element 202 represents a selectively cured portion 202 of a new layer 28 of the photocurable resin 8. As illustrated, coater 42 is translating from left to right (in the +Y direction) to level the photocurable resin 8 upper surface 24 to the build plane 22. As the coater 42 is translating, it leaves a fluidic disturbance or wake that affects part or all of an exclusion zone 204 that follows with the coater 42. A combination of a lateral area 206 containing both the coater 42 and the exclusion zone 204 can be referred to as a “digital shadow” 208. As part of method 100, controller 34 is configured to compute and track a position of the digital shadow 208 within build plane 22 during the transit of the coater 32 across the build plane. The digital shadow has a computed width W along the transit direction Y and a length L equal to a length of the build plane along X.

FIG. 6B illustrates the coater 42 translating over the selectively cured portion 202 of new layer 28. As soon as the exclusion zone 204 has passed a trailing edge or portion 210 of the selectively cured portion 202, the imaging system 30 can begin selectively curing a trailing and level portion 212 of the selectively cured portion 202 of new layer 28. But the controller excludes curing within the digital shadow 208.

FIG. 6C illustrates the digital shadow 208 having translated past the selectively cured portion 202. At this point, the controller is completing a cure of the entire selectively cured portion 202. The selective curing is occurring while coater 42 completes the lateral translation to or past the edge of build plane 22.

By computing and tracking a “digital shadow” 208 on this way, controller 34 is able to parallel process the process of translating the coater 42 without creating wake-related artifacts in the new selectively cured portion 202 of new layer 28. This substantially reduces a time required for coating and selectively curing and therefore increases productivity of the 3D printing system 2.

The specific embodiments and applications thereof described above are for illustrative purposes only and do not preclude modifications and variations encompassed by the scope of the following claims.

What is claimed:

1. A three-dimensional (3D) printing system configured to manufacture a 3D article comprising:
a vessel configured to contain a photocurable resin;
a coating subsystem including a coater blade;
a build plate coupled to a vertical movement mechanism;
an imaging system configured to selectively image the photocurable resin over a build plane; and
a controller programmed to:
operate the vertical movement mechanism to position an upper surface of the build plate or 3D article at the build plane;
translate a lower edge of the coater blade over the build plane along a scan direction; and
concurrent with translating the lower edge of the coater blade, operate the imaging system to selectively image the build plane while maintaining an exclusion zone that includes a digital shadow that translates with the coater blade, the digital shadow includes an area of the coater blade and a fluidic wake area that follows the coater blade.

2. The three-dimensional (3D) printing system of claim 1 wherein the fluidic wake area has a width W relative to the scan direction and wherein the controller computes W based at least partly upon a layer thickness of resin between the build plane and an upper face of a cured layer.

3. The three-dimensional (3D) printing system of claim 1 wherein the fluidic wake area has a width W relative to the scan direction and wherein the controller computes W based at least partly upon a viscosity of the photocurable resin.

4. The three-dimensional (3D) printing system of claim 1 wherein the fluidic wake area has a width W relative to the scan direction and wherein the controller computes W based at least partly upon an edge geometry of the lower edge of the coater blade.

5. The three-dimensional (3D) printing system of claim 1 wherein the lower edge of the coater blade is translated with a scan speed determined at least partly based upon a cure time for a layer of the photocurable resin.

6. The three-dimensional (3D) printing system of claim 1 wherein the imaging system includes a laser configured to output an energy beam and a scanner configured to scan the energy beam over the build plane.

7. The three-dimensional (3D) printing system of claim 1 wherein the imaging system includes a light source configured to output radiation, a spatial light modulator configured to modulate radiation received from the light source, and projection optics configured to focus modulated radiation received from the spatial light modulator onto the build plane.

8. A method of manufacturing a three-dimensional (3D) article comprising:
providing a 3D printing system including:
a vessel configured to contain a photocurable resin;
a coating subsystem including a coater blade;
a build plate coupled to a vertical movement mechanism; and
an imaging system configured to selectively imager the photocurable resin over a build plane;
operating the vertical movement mechanism to position an upper surface of the build plate or 3D article at the build plane;
translating a lower edge of the coater blade over the build plane along a scan direction; and
concurrent with translating the lower edge of the coater blade, operating the imaging system to selectively image the build plane while maintaining an exclusion zone that includes a digital shadow that translates with the coater blade, the digital shadow includes an area of the coater blade and a fluidic wake area that follows the coater blade.

9. The method of claim 6 wherein the fluidic wake area has a width W along the scan direction, the method further including computing W based at least partly upon a layer thickness of resin between the build plane and an upper face of a cured layer.

10. The method of claim 8 wherein the fluidic wake area has a width W along the scan direction, the method further including computing W based at least partly upon a viscosity of the photocurable resin.

11. The method of claim 8 wherein the fluidic wake area has a width W along the scan direction, the method further including computing W based at least partly upon an edge geometry of the lower edge of the coater blade.

12. The method of claim 8 wherein the lower edge of the coater blade is translated with a scan speed determined at least partly based upon a cure time for a layer of the photocurable resin.

13. The method of claim 8 wherein the imaging system includes a laser and a scanner, the method includes:
operating the laser to output an energy beam; and
operating the scanner to scan the energy beam over the build plane.

14. The method of claim 8 wherein the imaging system includes a light source, a spatial light modulator, and projection optics, the method includes:
operating the light source to output radiation; and
operating the spatial light modulator to selectively modulate the radiation output from the light source; and
wherein the projection optics focus modulated light from the spatial light modulator onto the build plane.

15. A non-transient storage medium storing software instructions for controlling a three-dimensional (3D) printing system, the 3D printing system including:
a vessel configured to contain a photocurable resin;
a coating subsystem including a coater blade;
a build plate coupled to a vertical movement mechanism; and
an imaging system configured to selectively imager the photocurable resin over a build plane;
in response to execution by a processor, the software instructions are configured to:
operate the vertical movement mechanism to position an upper surface of the build plate or 3D article at the build plane;
translate a lower edge of the coater blade over the build plane along a scan direction; and
concurrent with translating the lower edge of the coater blade, operate the imaging system to selectively image the build plane while maintaining an exclusion zone that includes a digital shadow that translates with the coater blade, the digital shadow includes an area of the coater blade and a fluidic wake area that follows the coater blade.

16. The non-transient storage medium of claim 15 wherein the fluidic wake area has a width W relative to the scan direction and wherein the software instructions are further configured to compute W based at least partly upon a layer thickness of resin between the build plane and an upper face of a cured layer.

17. The non-transient storage medium of claim 15 wherein the fluidic wake area has a width W relative to the scan direction and wherein the software instructions are further configured to compute W based at least partly upon a viscosity of the photocurable resin.

18. The non-transient storage medium of claim 15 wherein the fluidic wake area has a width W relative to the scan direction and wherein the software instructions are further configured to compute W based at least partly upon an edge geometry of the lower edge of the coater blade.

19. The non-transient storage medium of claim 15 wherein the lower edge of the coater blade is translated with a scan speed determined at least partly based upon a cure time for a layer of the photocurable resin.
